(19) United States
(12) Patent Application Publication
(10) Pub. No.: US 2021/0340375 A1
(43) Pub. Date: Nov. 4, 2021

(54) POLYMER COATED PARTICLES FOR POLYMER CONCRETE COMPOSITIONS

(71) Applicant: Dow Global Technologies LLC, Midland, MI (US)

(72) Inventors: Kaoru Aou, Lake Jackson, TX (US); Sachit Goyal, Houston, TX (US); Adam C. Colson, Boise, ID (US); Juan Carlos Medina, Lake Jackson, TX (US); Phillip S. Athey, Lake Jackson, TX (US); Arjun Raghuraman, Pearland, TX (US)

(21) Appl. No.: 16/319,081

(22) PCT Filed: Sep. 12, 2017
(86) PCT No.: PCT/US2017/051181

§ 371 Date: Jan. 18, 2019

Related U.S. Application Data
(60) Provisional application No. 62/395,452, filed on Sep. 16, 2016.

(51) Int. Cl. C08L 75/08; C09D 177/06; C09D 161/06; C09D 163/00; C09D 175/08

(52) U.S. Cl. CPC C08L 75/08; C09D 177/06; C09D 175/08; C09D 163/00; C09D 161/06

(57) ABSTRACT

A polymer concrete composition has a base composition including a first isocyanate component and a first isocyanate reactive component, and one or more pre-coated aggregates that each has a base substrate and a two-component reaction product polymeric coating on an outer surface of the base substrate. The polymeric coating is the reaction product of a second isocyanate component and a second isocyanate-reactive component.

### FIELD

Embodiments relate to pre-coated aggregates for polymer concrete compositions, polymer concrete compositions including pre-coated aggregates, methods of manufacturing the pre-coated aggregates, and methods of manufacturing the polymer concrete compositions including the coating articles.

### INTRODUCTION

Polymer concrete may be used for new construction or repairing of old concrete (repairing a concrete substrate). For example, the polymer concrete may be used for roadway applications (such as for vehicular traffic, airport runways, etc.) and/or structural and infrastructure applications (such as for buildings, swimming pools, sewers, etc.) Polymer concrete may be prepared by mixing aggregates and polymers and then curing the mixture to form a polymer matrix having the aggregate embedded therewithin. The polymers may be thermosetting polymers and/or thermoplastic polymers. The polymers may impart adhesive properties to the cured polymer concrete, e.g., for use in repair applications. For example, the polymers may include thermosetting polymers that when cured provide high thermal stability, high compressive strength, and/or resistance to corrosive species and/or contaminates.

Polymeric coatings (which include set in place coatings, spray coatings, powder coatings, and paints) may be used to enhance the properties of coated substrates. For example, the protective coatings may be designed to increase compressive strength, adhesion properties, disparity of thicknesses of substrates, and/or controlled permeation of corrosive species and/or contaminants.

### SUMMARY

Embodiments may be realized by a polymer concrete composition having a base composition including a first isocyanate component and a first isocyanate reactive component, and one or more pre-coated aggregates that each has a base substrate and a two-component reaction product polymeric coating on an outer surface of the base substrate. The polymeric coating is the reaction product of a second isocyanate component and a second isocyanate-reactive component.

### BRIEF DESCRIPTION OF THE DRAWINGS

Features of the embodiments will become more apparent to those of ordinary skill in the art by describing in detail exemplary embodiments thereof with reference to the attached figures, in which:

FIG. 1 illustrates exemplary embodiments (a) and (b) of the pre-coated aggregate;

FIG. 2 provides Schematic (a) illustrating polyurethane polymers and polyisocyanurate polymers and Schematic (b) illustrating the preformed isocyanurate tri-isocyanate;

FIG. 3 provides Schematic (a) illustrating the reaction between a carboxylic acid and an isocyanate and Schematic (b) illustrating an exemplary route that may be used to prepare pre-cured resin coated aggregates according to an exemplary embodiment that utilizes the reaction between a carboxylic acid and an isocyanate; and

FIG. 4 provides Schematic (a) illustrating an exemplary route that may be used to prepare to synthesize of acid terminated polyethers and Schematic (b) illustrating an exemplary route that may be used to prepare the reaction product of an acid-terminated polyether with an isocyanate to generate an amide based coating.

### DETAILED DESCRIPTION

It has been proposed to additional include sand thinly coated with an emulsion in an asphalt concrete composition, e.g., as discussed in U.S. Pat. No. 5,219,901. It has been proposed in International Publication No. WO 2002/072499 to add chemically treated fibers to cement composites that include a hydraulic binder and aggregates. It has been proposed in U.S. Pat. No. 8,653,163 to coat aggregates using a polymer dispersion for improving the stability of concrete to the alkali-silica reactions, but the thin film on the aggregate formed using the polymer dispersion is to enable the addition of functionality to the aggregate. However, embodiments relate to a polyurethane based polymer concrete that includes aggregates pre-coated with a two component polymer system. In particular, two component polymer systems enable the formation of a strong and stable polymer matrix prepared as the reaction product of two separate components. The reaction product may be the product of an irreversible reaction product. The resultant coatings may provide the benefit of being formulated to maintain its properties even when exposed to varying temperatures.

Further, the coated aggregates may reduce the coarseness of the particles. In particular, coarser particles may break down or crush more readily under stress, e.g., based on fewer particle-to-particle contact points able to distribute the load throughout the mesh. Accordingly, a coating that imparts increased smoothness to the aggregates may enhance the properties of the aggregate.

It is proposed to combine the use of polymeric coatings in polymer concrete. It particular, it is proposed to coat the aggregate used in polymer concrete with a polymer coating. The aggregate may be a solid particle having a high melting point, such as aggregates that include silica, ceramic, quartz, granite, and/or limestone. The polymeric coating may include any one of, or combination thereof, of a polyurethane based coating, an epoxy based coating, a phenolic resin based coating, a preformed isocyanurate based coating, and an amide based coating. Other exemplary polymeric coatings that may be usable to pre-coat aggregates include radical or photo-cured acrylic polymer coatings and an unsaturated polyester resin based coating. The aggregate may be coated with one or more polymeric coatings prior to forming the polymer concrete composition, such that the coated aggregate may be a pre-coated aggregate that is added to the polymer concrete composition.

The polymer concrete composition may include one or more aggregates with different polymeric coatings and/or combinations of polymeric coatings. The polymeric concrete composition may include a mixture of pre-coated aggregate and non-coated aggregate (e.g., at a weight ratio of 1:9, 2:8, 3:7, 4:6, 5:5, 4:6, 3:7, 8:2, 9:1, relative to each other). In addition to the aggregate, the polymer concrete composition includes a polyurethane base composition for forming the polymer matrix of the cured polymer concrete. The polymer concrete composition may be applied to a surface as a liquid or semi-solid composition and may cure in place to form polymer concrete. By cured it is meant the composition has been sufficiently toughened or hardened (e.g., by cross-linking of polymer chains), such that the material has converted from a liquid state to a solid/semi-solid state.

The pre-coated aggregate may include one of more coatings that allow for one or more function coating. The coating may comprise from 0.1 wt % to 10.0 wt % (e.g., 0.3 wt % to 5.0 wt %, 0.3 wt % to 4.0 wt %, 0.3 wt % to 3.5 wt %, etc.) of a total weight of the pre-coated aggregate. In exemplary embodiments, the pre-coated aggregate includes a coating formed on a base substrate (e.g., directly on so as to encompass and/or substantially encompass). The base substrate may be a particle such as silica sand.

The pre-coated aggregate is formed prior to forming the polymer concrete composition, so as to be a pre-coated aggregate. The pre-coated aggregate may be partially and/or fully cured prior to forming the polymer concrete composition. By cured it is meant the coating has been sufficiently toughened or hardened by cross-linking of polymer chains, such that the material has converted from a liquid state to a solid/semi-solid state. For example, the pre-coated aggregate may be formed at least 1 hour, at least one day, at least one week, at least one month, at least one year, etc., prior to forming the polymer concrete composition. The polymer concrete composition may be formed at the location of intended use, in other words the pre-coated aggregate and the components used to form the polymer matrix may be mixed on site right before use. For example, the two component polymer system based coating may be pre-coated on the aggregates (e.g., prior to transporting the pre-coated aggregates to the site of use) to simplify use thereof in polymer concrete compositions for in field applications. In such in field applications, the pre-coated aggregates and a base composition for the polymer concrete may be mixed at the site of use.

Referring to FIG. 1, embodiment (a) includes an underlying coating coated on an outer surface of a base substrate such as sand and an overlying coating coated on the underlying coating. Embodiment (b) includes a single coating that includes both an additive and a polymer resin. In embodiment (b), the additive may be dispersed in the polymer resin matrix. In particular, the pre-coated aggregate may include one or more additives embedded under, on, and/or within the polymeric coating(s). The one or more additives may be added during a process of forming the pre-coated aggregate and/or may be sprinkled onto a previously coated aggregate to form the coating in combination with an additive based coating. For example, the one or more additives may be incorporated into an isocyanate-reactive component for forming the coating, an isocyanate component (e.g., a polyisocyanate and/or a prepolymer derived from an isocyanate and a prepolymer formation isocyanate-reactive component) for forming the coating, the prepolymer formation isocyanate-reactive component, and/or a prepolymer derived from an isocyanate and a one component system formation isocyanate-reactive component. Exemplary additives include pigments and contaminant removal/recovery substances.

Embodiments further relate to a cured polymer concrete that includes the polymer concrete composition prepared using the base composition and one or more pre-coated aggregates. Embodiments also relate to a method of preparing the polymer concrete composition, which method includes providing the one or more pre-coated aggregates in a container, adding the first isocyanate component and the first isocyanate-reactive component to the container, and mixing the one or more pre-coated aggregates and the base composition. Embodiments further relate to a method of repairing a concrete substrate using the polymer concrete composition, the method comprising providing the one or more pre-coated aggregates in a container, adding the first isocyanate component and the first isocyanate-reactive component to the container, mixing the one or more pre-coated aggregates and the base composition to form a mixed polymer concrete composition, and applying the mixed polymer concrete composition to the concrete substrate. The container may be a small container, e.g., used to repair a small area of a concrete substrate, or the container may be a large container, e.g., used to prepare a large concrete substrate or repair a large area of a concrete substrate. The concrete substrate may be usable in or to form roadway applications and/or structural and infrastructure applications (such as for buildings, swimming pools, sewers, etc.)

### Base Composition

The base composition, also referred to as a binder for the polymer concrete, may be prepared as an one-component system or a two-component system. Whereas, the one-component system may be a preformed (pre-reacted) curable polyurethane based composition that is mixed as a single component with the pre-coated aggregate and allowed to cure to form the polymer concrete. For example, the one-component system may be a moisture cured system. The two-component system may be a composition in which separate components are combined immediately before, during, or after mixing with the pre-coated aggregate and the resultant reaction mixture is allowed to cure to form the polymer concrete. The resultant binder may include polyurethane, polyurea, and/or poly(urethane-isocyanurate) based polymers. For example, the resultant binder may be a polyurethane based binder that forms an elastomeric matrix surrounding the pre-coated aggregates.

The resultant binder may, e.g., have a resilience at 5% deflection of at least 80% (e.g., at least 90%, at least 94%, etc.). The resultant binder may have a Shore A hardness of at least 75 (at least 80, from 80 to 100, from 80 to 90, etc.), according to ASTM D240. The resultant binder may have a gel time at 25° C. of at least 3 minutes (e.g., 3 to 10 minutes, 4 to 8 minutes, etc.) to allow for appropriate in-field use (e.g., to allow for adequate mixing time with the pre-coated aggregates and/or to allow for an adequate in place cure time). The resultant binder may have a tensile strength of at least 1000 psi (e.g., from 1000 psi to 5000 psi, from 1000 psi to 3000 psi, from 1000 psi to 2000 psi, etc.), according to ASTM D412. The resultant binder may have a compressive strength of at least 1000 psi (e.g., from 1000 psi to 5000 psi, from 2000 psi to 4000 psi, from 2000 psi to 3000 psi), according to ASTM C579B.

For example, the base composition for forming the polymer matrix of the polymer concrete (i.e., the cured binder) may include an isocyanate component and an isocyanate-reactive component, which may be introduced as a part of a one-component or two-component system. A polyurethane based matrix may be formed as a reaction product of the isocyanate component and the isocyanate-reactive component. The isocyanate based component includes at least one isocyanate, such as at least one polyisocyanate, at least one isocyanate terminated prepolymer derived from at least one polyisocyanate, and/or at least one quasi-prepolymers derived from the polyisocyanates. The isocyanate-reactive component includes one or more polyols. In exemplary embodiments, the isocyanate component and/or the isocyanate-reactive component may include one or more additional additives.

With respect to the isocyanate component for the base composition, exemplary polyisocyanates include aromatic, cycloaliphatic, and aliphatic polyisocyanates. Exemplary isocyanates include toluene diisocyanate (TDI) and variations thereof known to one of ordinary skill in the art, and diphenylmethane diisocyanate (MDI) and variations thereof known to one of ordinary skill in the art. Other isocyanates known in the polyurethane art may be used, e.g., known in the art for polyurethane based coatings. Examples, include modified isocyanates, such as derivatives that contain biuret, urea, carbodiimide, allophanate and/or isocyanurate groups may also be used. Exemplary available isocyanate based products include HYPERLAST™ products, PAPI™ products, ISONATE™ products and VORANATE™ products, VORASTAR™ products, HYPOL™ products, TERAFORCE™ Isocyanates products, available from The Dow Chemical Company.

If included, the isocyanate-terminated prepolymer may have a free isocyanate group (NCO) content of 1 wt % to 35 wt % (e.g., 5 wt % to 30 wt %, 10 wt % to 30 wt %, 15 wt % to 25 wt %, 15 wt % to 20 wt %, etc.), based on the total weight of the prepolymer. If present, one or more isocyanate terminated prepolymers may account for 20 wt % to 100 wt % (e.g., from 20 wt % to 80 wt %, from 30 wt % to 70 wt %, from 40 wt % to 60 wt %, from 45 wt % to 55 wt %, etc.) of the isocyanate component, and a remainder (if present) of the isocyanate component may be one or more polyisocyanates and/or at least one additives. If present, one or more isocyanate-terminated prepolymers may account for 5 wt % to 70 wt % (e.g., from 20 wt % to 65 wt % and/or from 35 wt % to 60 wt %) of the total weight of the reaction mixture for forming the cured composition.

The isocyanate-terminated prepolymer may be formed by the reaction of another isocyanate component with another isocyanate-reactive component (both different and separate from the isocyanate-component and isocyanate-reactive component for forming the cured composition), in which the isocyanate component is present in stoichiometric excess. For example, when a polyol contains an active hydroxyl group, the reaction of the active hydroxyl group with an isocyanate moiety results in the formation of a urethane linkage, as such the prepolymer may include both a urethane linkage and an isocyanate terminal group. For example, the prepolymer may be prepared in an one-pot procedure using at least one polyether polyol. As an example, the polyether polyol(s) used in preparing the prepolymer is derived from propylene oxide, ethylene oxide, and/or butylene oxide.

An isocyanate index for the base composition may be from 95 to 300 (e.g., 101 to 200, 110 to 150, etc.). By isocyanate index, it is meant a ratio of equivalents of isocyanate groups in the reaction mixture for forming the cured composition to the active hydrogen atoms in the reaction mixture for forming the cured composition, for forming the polyurethane polymers, multiplied by 100. Said in another way, the isocyanate index is the molar equivalent of isocyanate (NCO) groups divided by the total molar equivalent of isocyanate-reactive hydrogen atoms present in a formulation, multiplied by 100. As would be understood by a person of ordinary skill in the art, the isocyanate groups in the reaction mixture for forming the cured composition may be provided through the isocyanate component, and the active hydrogen atoms may be provided through the isocyanate reactive component. The isocyanate index for forming the isocyanate-terminated prepolymer may be greater than 200.

The isocyanate-reactive component for forming the binder that includes the polyurethane based matrix (including a polyurethane/epoxy hybrid based matrix) includes one or more polyols. The one or more polyols may have a number average molecular weight from 60 g/mol to 6000 g/mol (e.g., 150 g/mol to 3000 g/mol, 150 g/mol to 2000 g/mol, 150 g/mol to 1500 g/mol, 150 g/mol to 1000 g/mol, 200 g/mol to 900 g/mol, 300 g/mol to 800 g/mol, 400 g/mol to 700 g/mol, 500 g/mol to 700 g/mol, etc.). The one or more polyols have on average from 1 to 8 hydroxyl groups per molecule, e.g., from 2 to 4 hydroxyl groups per molecule. For example, the one or more polyols may independently be a diol or triol. The isocyanate-reactive component may include at least 80 wt % and/or at least 90 wt % of one or more polyols.

The one or more polyols may be alkoxylates derived from the reaction of propylene oxide, ethylene oxide, and/or butylene oxide with an initiator. Initiators known in the art for use in preparing polyols for forming polyurethane polymers may be used. For example, the one or more polyols may be an alkoxylate of any of the following molecules, e.g., ethylene glycol, diethylene glycol, triethylene glycol, 1,2-propanediol, dipropylene glycol, tripropylene glycol, 1,4-butanediol, 1,6-hexanediol, trimethylolpropane, sorbitol, sucrose, and glycerine. According to exemplary embodiments, the one or more polyols may be derived from propylene oxide and ethylene oxide, of which less than 20 wt % (e.g., and greater than 5 wt %) of polyol is derived from ethylene oxide, based on a total weight of the alkoxylate. Exemplary catalysts for forming the polyols include, e.g., potassium hydroxide (KOH), CsOH, boron trifluoride, and double-metal cyanide complex (DMC) catalysts such as a zinc hexacyanocobaltate or a quaternary phosphazenium compound.

For example, the polyol may contain terminal blocks derived from ethylene oxide blocks. According to another exemplary embodiment, the polyol is derived from butylene oxide or a combination of butylene oxide and propylene oxide. For example, the polyol may contain terminal blocks derived from butylene oxide. According to other exemplary embodiments, the polyol may be the initiator themselves as listed above, without any alkylene oxide reacted to it.

In exemplary embodiments, the butylene oxide based polyol may be a polyoxybutylene-polyoxypropylene polyol that includes at least 50 wt %, at least 60 wt %, at least 70 wt %, at least 80 wt %, and/or at least 90 wt % of butylene oxide, and a remainder of at least 5 wt % of propylene oxide and/or ethylene oxide, based on the total alkylene oxide content of the butylene oxide based polyol. In other exemplary embodiments, the butylene oxide based polyol may be an all butylene oxide polyol, i.e., 100 wt % of the alkylene oxide content is butylene oxide.

In exemplary embodiments, the one or more polyols may include at least one poly(propylene glycol) based diol having a number average molecular weight from 400 g/mol to 4000 g/mol. For hydrophobicity (which may be desirable for water-repellent concrete) the one or more polyols may include at least one polyol (butylene glycol) based diol having a number average molecular weight from 400 g/mol to 4000 g/mol. The one or more polyols maybe EO-capped to have higher fraction of primary hydroxyl groups as end groups.

In exemplary embodiments, the isocyanate-reactive component may include alkoxylates of ammonia or primary or secondary amine compounds, e.g., as aniline, toluene diamine, ethylene diamine, diethylene triamine, piperazine, and/or aminoethylpiperazine. For example, the isocyanate-reactive component may include polyamines that are known in the art for use in forming polyurethane-polyurea polymers. The isocyanate-reactive component may include one or more polyester polyols having a hydroxyl equivalent weight of at least 500, at least 800, and/or at least 1,000. For example, polyester polyols known in the art for forming polyurethane polymers may be used. The isocyanate-reactive component may include polyols with fillers (filled polyols), e.g., where the hydroxyl equivalent weight is at least 500, at least 800, and/or at least 1,000. The filled polyols may contain one or more copolymer polyols with polymer particles as a filler dispersed within the copolymer polyols. Exemplary filled polyols include styrene/acrylonitrile (SAN) based filled polyols, polyharnstoff dispersion (PHD) filled polyols, and polyisocyanate polyaddition products (PIPA) based filled polyols. The isocyanate-reactive component may include a primary hydroxyl containing alcohol, such as a polybutadiene, a polytetramethylene ether glycol (PTMEG), a polypropylene glycol (PPG), a polyoxypropylene, and/or a polyoxyethylene-polyoxypropylene.

Exemplary available polyol based products include VORANOL™ products, TERAFORCE™ Polyol products, VORAPEL™ products, SPECFLEX™ products, VORALUX™ products, PARALOID™ products, VORARAD™ products, HYPERLAST™ products, VORANOL™ VORACTIV™ products, and SPECFLEX™ ACTIV, available from The Dow Chemical Company.

The isocyanate-reactive component for forming the polyurethane based matrix may further include a catalyst component. The catalyst component may include one or more catalysts. Catalysts known in the art, such as trimerization catalysts known in art for forming polyisocyanates trimers and/or urethane catalyst known in the art for forming polyurethane polymers and/or coatings may be used. In exemplary embodiments, the catalyst component may be pre-blended with the isocyanate-reactive component, prior to forming the coating (e.g., an undercoat or a sulfide recovery outer coating).

Exemplary trimerization catalysts include, e.g., amines (such as tertiary amines), alkali metal phenolates, alkali metal alkoxides, alkali metal carboxylates, and quaternary ammonium carboxylate salts. The trimerization catalyst may be present, e.g., in an amount less than 5 wt %, based on the total weight of the isocyanate-reactive component. Exemplary urethane catalyst include various amines, tin containing catalysts (such as tin carboxylates and organotin compounds), tertiary phosphines, various metal chelates, and metal salts of strong acids (such as ferric chloride, stannic chloride, stannous chloride, antimony trichloride, bismuth nitrate, and bismuth chloride). Exemplary tin-containing catalysts include, e.g., stannous octoate, dibutyl tin diacetate, dibutyl tin dilaurate, dibutyl tin dimercaptide, dialkyl tin dialkylmercapto acids, and dibutyl tin oxide. The urethane catalyst, when present, may be present in similar amounts as the trimerization catalyst, e.g., in an amount less than 5 wt %, based on the total weight of the isocyanate-reactive component. The amount of the trimerization catalyst may be greater than the amount of the urethane catalyst. For example, the catalyst component may include an amine based trimerization catalyst and a tin-based urethane catalyst.

In exemplary embodiments, use of the catalyst component may be avoided, such that direct addition of one or more catalysts to the base composition is excluded/avoided, when the base composition is mixed with the pre-coated aggregates (e.g., when catalyst component was used to form the pre-coated aggregates).

### Polyurethane Pre-Coated Aggregate

Similar to the polyurethane based matrix formed from the base composition, the polyurethane pre-coated may be the reaction product of an isocyanate component and an isocyanate-reactive component, which may be introduced as a part of a one-component or two-component system. For a polyurethane based matrix, the isocyanate component may include a polyisocyanate and/or an isocyanate-terminated prepolymer and the isocyanate-reactive component may include a polyether polyol. Exemplary isocyanates, polyols, and additives (such as catalysts) are the same as discussed above with respect to the base composition.

The isocyanate-reactive component includes at least a polyol that has a number average molecular weight from 30 g/mol to 6000 g/mol (and optionally additional polyols) and includes a catalyst component having at least a catalyst (and optionally additional catalysts). The mixture for forming the polyurethane based matrix may have an isocyanate index that is at least 60. The isocyanate index may be less than 100 and/or less than 95.

For example, the isocyanate-reactive component may include at least one low molecular weight polyol having a number average molecular weight from 60 to 1500 g/mol. For example, each low molecular weight polyol may be derived from at least 90 wt % of ethylene oxide or butylene oxide, based on the total weight of oxides. For example, the at least one low molecular weight polyol may account for at least 70 wt % of the total polyols used to form the polyurethane coating.

### Epoxy Pre-Coated Aggregate

For example, epoxy resin based coatings (e.g., based on epoxy and epoxy hardener chemistry) have been proposed for use in forming pre-coated aggregates. As used herein, epoxy based coatings encompass the chemistry of an epoxy resin and an amine based epoxy hardener, with an amino hydrogen/epoxy resin stoichiometric ratio range over all possible stoichiometric ratios (e.g., from 0.60 to 3.00, from 0.60 to 2.00, from 0.70 to 2.0, etc.). Polyurethane pre-coated aggregates have been proposed for use polymer concrete compositions. Polyurethanes offer various advantages as coatings, e.g., such as ease of processing, base stability, and/or rapid cure rates that enable short cycle times for forming the coating. Polyurethane/epoxy hybrid coatings incorporate both epoxy based chemistry and polyurethane based chemistry to form hybrid polymers. For example, polyurethane/epoxy hybrid coatings may be formed by mixing and heating an epoxy resin containing hydroxyl groups, an isocyanate component (such as an isocyanate or an isocyanate-terminated prepolymer, and optionally a polyol component (e.g., may be excluded when an isocyanate-terminated prepolymer is used). Thereafter, an epoxy hardener may be added to the resultant polymer. Liquid epoxy resins known in the art may be used to form such a coating.

For example, for the epoxy based matrix, the liquid epoxy resin may be cured by one or more hardener, which may be any conventional hardener for epoxy resins. Conventional hardeners may include, e.g., any amine or mercaptan with at least two epoxy reactive hydrogen atoms per molecule, anhydrides, phenolics. In exemplary embodiments, the hardener is an amine where the nitrogen atoms are linked by divalent hydrocarbon groups that contain at least 2 carbon atoms per subunit, such as aliphatic, cycloaliphatic, or aromatic groups. For example, the polyamines may contain from 2 to 6 amine nitrogen atoms per molecule, from 2 to 8 amine hydrogen atoms per molecule, and/or 2 to 50 carbon atoms. Exemplary polyamines include ethylene diamine, diethylene triamine, triethylene tetramine, tetraethylene pentamine, pentaethylene hexamine, dipropylene triamine, tributylene tetramine, hexamethylene diamine, dihexamethylene triamine, 1,2-propane diamine, 1,3-propane diamine, 1,2-butane diamine, 1,3-butane diamine, 1,4-butane diamine, 1,5-pentane diamine, 1,6-hexane diamine, 2-methyl-1,5-pentanediamine, and 2,5-dimethyl-2,5-hexanediamine; cycloaliphatic polyamines such as, for example, isophoronediamine, 1,3-(bisaminomethyl)cyclohexane, 4,4′-diaminodicyclohexylmethane, 1,2-diaminocyclohexane, 1,4-diamino cyclohexane, isomeric mixtures of bis(4-aminocyclohexyl)methanes, bis(3-methyl-4-aminocyclohexyl)methane (BMACM), 2,2-bis(3-methyl-4-aminocyclohexyl)propane (BMACP), 2,6-bis(aminomethyl)norbornane (BAMN), and mixtures of 1,3-bis(aminomethyl)cyclohexane and 1,4-bis(aminomethyl)cyclohexane (including cis and trans isomers of the 1,3- and 1,4-bis(aminomethyl)cyclohexanes); other aliphatic polyamines, bicyclic amines (e.g., 3-azabicyclo[3.3.1]nonan); bicyclic imines (e.g., 3-azabicyclo[3.3.1]non-2-ene); bicyclic diamines (e.g. 3-azab‘i’cyclo[3.3.1]nonan-2-amine); heterocyclic diamines (e.g., 3,4 diaminofuran and piperazine); polyamines containing amide linkages derived from “dimer acids” (dimerized fatty acids), which are produced by condensing the dimer acids with ammonia and then optionally hydrogenating; adducts of the above amines with epoxy resins, epichlorohydrin, acrylonitrile, acrylic monomers, ethylene oxide, and the like, such as, for example, an adduct of isophoronediamine with a diglycidyl ether of a dihydric phenol, or corresponding adducts with ethylenediamine or m-xylylenediamine; araliphatic polyamines such as, for example, 1,3-bis(aminomethyl)benzene, 4,4′diaminodiphenyl methane and polymethylene polyphenylpolyamine; aromatic polyamines (e.g., 4,4′-methylenedianiline, 1,3-phenylenediamine and 3,5-diethyl-2,4-toluenediamine); amidoamines (e.g., condensates of fatty acids with diethylenetriamine, triethylenetetramine, etc.); polyamides (e.g., condensates of dimer acids with diethylenetriamine, triethylenetetramine; oligo(propylene oxide)diamine; and Mannich bases (e.g., the condensation products of a phenol, formaldehyde, and a polyamine or phenalkamines). Mixtures of more than one diamine and/or polyamine can also be used.

### Phenolic Resin Pre-Coated Aggregate

For example, phenolic resins have been proposed for use in forming pre-coated aggregates. The phenolic resin based matrix may be prepared using curable or pre-cured phenolic materials, such as arylphenol, alkylphenol, alkoxyphenol, and/or aryloxyphenol based phenolic materials. The phenolic resin matrix may be formed using one or more curable or pre-cured phenolic thermoset resins. The phenolic thermoset resins may be made by crosslinking phenol-formaldehyde resins with crosslinkers (such as hexamethylenetetramine) Exemplary phenolic resin coatings for proppants are discussed in U.S. Pat. Nos. 3,929,191, 5,218,038, 5,948,734, 7,624,802, and 7,135,231.

According to exemplary embodiments, there are two types of phenolic resins that may be used (1) Novolac (phenol to formaldehyde ratio is >1), an exemplary structure is shown below where n is an integer of 1 or greater, and (2) Resole (phenol to formaldehyde ratio is <1), an exemplary structure is shown below where n is an integer of 1 or greater. Novolac resins may use a crosslinker. Resole resins may not use a crosslinker.

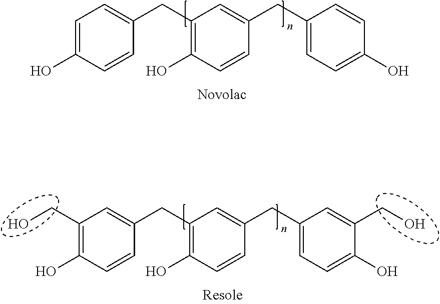

A silane coupling agent may be used, e.g., to generate bond strength, when forming a phenolic resin coating, an exemplary coating is discussed in U.S. Pat. No. 5,218,038. Optionally a lubricant may be added at the end of the process of forming the phenolic resin coating.

For forming an exemplary phenolic resin coating, Novolak resin or alkylphenol-modified novolak resin, or a mixture thereof, is added to the hot sand and mixed. Optionally, one or more additives, such as a silane coupling agent, may be added in a desired amount. Then, to the resultant mixture may be stirred until it has advanced above a desired melt point of the resin (e.g., 35° C. as a minimum). The degree of resin advancing or increasing in molecular weight during the mixing or coating may be important to achieve the desired melt point and resin composition properties. Water may then be added in an amount sufficient to quench the reaction.

### Preformed Isocyanate Trimer Pre-Coated Aggregate

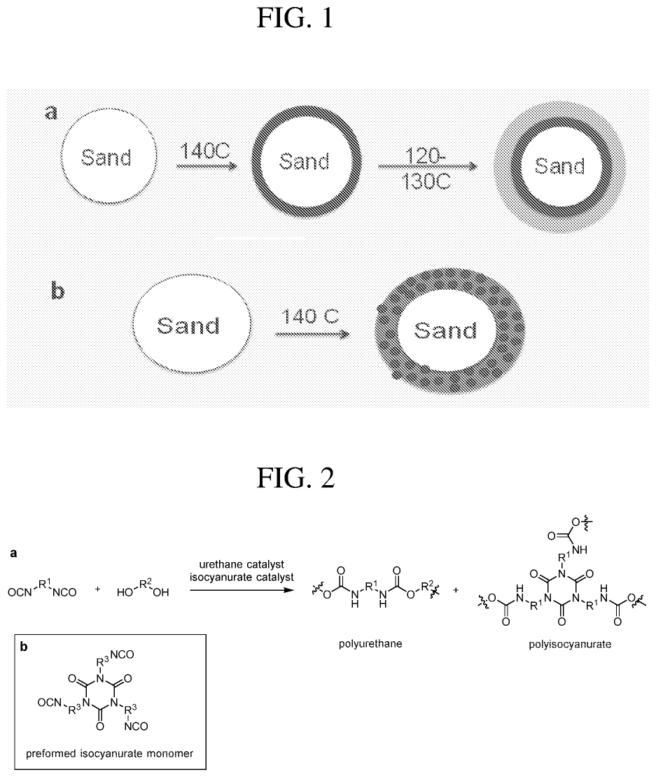

For example, preformed isocyanate trimers have been proposed for use in forming pre-coated aggregates, such as discussed in U.S. Provisional Patent Application No. 62/140,022. The coated may be formed using a mixture that includes one or more preformed isocyanurate tri-isocyanates and one or more curatives. The preformed isocyanurate tri-isocyanate may also be referred to herein as an isocyanate trimer and/or isocyanurate trimer. By preformed it is meant that the isocyanurate tri-isocyanate is prepared prior to making a coating that includes the isocyanurate tri-isocyanate there within. Accordingly, the isocyanurate tri-isocyanate is not prepared via in situ trimerization during formation of the coating. In particular, one way of preparing polyisocyanates trimers is by achieving in situ trimerization of isocyanate groups, in the presence of suitable trimerization catalyst, during a process of forming polyurethane polymers. For example, the in situ trimerization may proceed as shown below with respect to Schematic (a), in which a diisocyanate is reacted with a diol (by way of example only) in the presence of both a urethane catalyst and a trimerization (i.e. promotes formation of isocyanurate moieties from isocyanate functional groups) catalyst. The resultant polymer includes both polyurethane polymers and polyisocyanurate polymers, as shown in Schematic (a) of FIG. 2.

In contrast, referring to Schematic (b) of FIG. 2, in embodiments the preformed isocyanurate tri-isocyanate is provided as a separate preformed isocyanurate-isocyanate component, i.e., is not mainly formed in situ during the process of forming polyurethane polymers. The preformed isocyanurate tri-isocyanate may be provided in a mixture for forming the coating in the form of a monomer, and not in the form of being derivable from a polyisocyanate monomer while forming the coating. For example, the isocyanate trimer may not be formed in the presence of any polyols and/or may be formed in the presence of a sufficiently low amount of polyols such that a polyurethane forming reaction is mainly avoided (as would be understand by a person of ordinary skill in the art). With respect to the preformed isocyanurate tri-isocyanate, it is believed that the existence of isocyanurate rings leads to a higher crosslink density. Further, the higher crosslink density may be coupled with a high decomposition temperature of the isocyanurate rings, which may lead to enhanced temperature resistance. Accordingly, it is proposed to introduce a high level of isocyanurate rings in the coatings for aggregates using the preformed isocyanurate tri-isocyanates.

For example, the composition for forming the preformed isocyanate trimer pre-coated aggregate may include one or more preformed aliphatic isocyanate based isocyanurate tri-isocyanates, one or more preformed cycloaliphatic isocyanate based isocyanurate tri-isocyanates, or combinations thereof. In exemplary embodiments, the coating is derived from at least a preformed cycloaliphatic isocyanate based isocyanurate tri-isocyanate, e.g., the preformed cycloaliphatic isocyanate based isocyanurate tri-isocyanate may be present in an amount from 80 wt % to 100 wt %, based on the total amount of the isocyanurate tri-isocyanates used in forming the additional layer.

Exemplary preformed isocyanurate tri-isocyanates include the isocyanurate tri-isocyanate derivative of 1,6-hexamethylene diisocyanate (HDI) and the isocyanurate tri-isocyanate derivative of isophorone diisocyanate (IPDI). For example, the isocyanurate tri-isocyanates may include an aliphatic isocyanate based isocyanurate tri-isocyanates based on HDI trimer and/or cycloaliphatic isocyanate based isocyanurate tri-isocyanates based on IPDI trimer. Many other aliphatic and cycloaliphatic di-isocyanates that may be used (but not limiting with respect to the scope of the embodiments) are described in, e.g., U.S. Pat. No. 4,937,366. It is understood that in any of these isocyanurate tri-isocyanates, one can also use both aliphatic and cycloaliphatic isocyanates to form an preformed hybrid isocyanurate tri-isocyanate, and that when the term “aliphatic isocyanate based isocyanurate tri-isocyanate” is used, that such a hybrid is also included.

### Amide Pre-Coated Aggregate

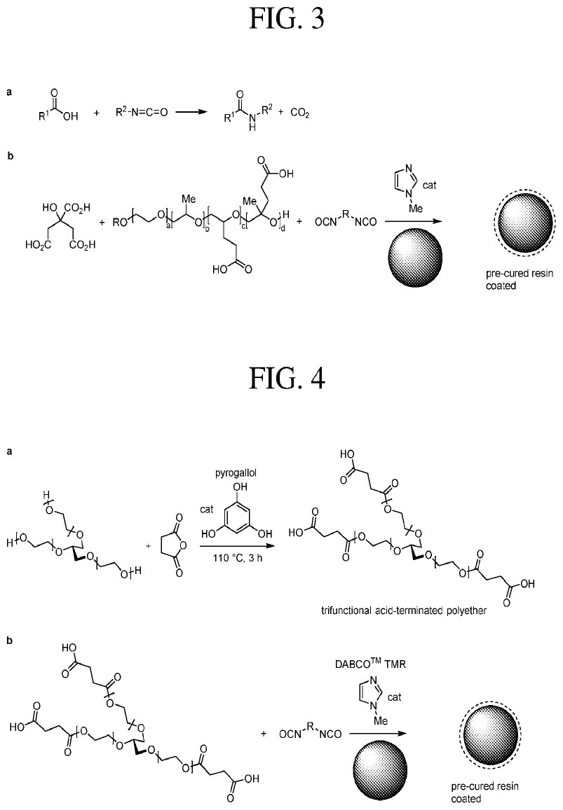

For example, an amide based coating has been proposed for use in forming pre-coated aggregates, such as discussed in U.S. Provisional Patent Application No. 62/347,252. The amide based coating is derived from the reaction between a carboxylic acid and an isocyanate, which results in an amide bond and CO₂ gas. For example, embodiments relate to proppant coatings that are formed from the reaction of a polycarboxylic acid and a polyisocyanate. Such resin coated proppants out of these compositions may display sufficient bond strength at temperatures as low as 50° C. Additionally, when incorporated with a suitable inorganic filler, such coatings may be utilized to capture contaminates such as 100% of H₂S from aqueous media containing. For example, the amide based coating may be an amide copolymer coating. The amide based coating may be derived from the reaction between a carboxylic acid and an isocyanate, which results in an amide bond and CO₂ gas. The amine bond forming reaction is as shown in the Schematic in FIG. 3. Referring to FIG. 3, Schematic (a) illustrates the reaction between a carboxylic acid and an isocyanate. Further, Schematic (b) illustrates an exemplary route that may be used to prepare pre-cured resin coated proppants according to an exemplary embodiment that utilizes the reaction between a carboxylic acid and an isocyanate.

For example, the amide based coating may be prepared using a carboxylic acid based copolymer that is prepared using one or more polyols, such as a polyester, polycarbonate, and/or polyether polyol. Referring to FIG. 4, Schematic (a) illustrates an exemplary route that may be used to prepare to synthesize of acid terminated polyethers. Further, Schematic (b) in FIG. 4 illustrates an exemplary route that may be used to prepare the reaction of acid-terminated polyether with isocyanate to generate an amide based coating.

With respect to the amide based coating, the polymer resin/matrix is the reaction product of an isocyanate component and an isocyanate-reactive component that includes (e.g., consistent essentially of) one or more carboxylic acids (e.g., one or more polycarboxylic acids). The isocyanate component may include at least one polyisocyanate and/or at least one isocyanate-terminated prepolymer and the isocyanate-reactive component may include at least one polyol such as a polyether polyol. Similarly, an optional one or more amide based undercoats (e.g., that includes the one or more additives embedded therewithin), may be the reaction product of a same or a different isocyanate component and a same or a different isocyanate-reactive component. For example, the optional one or more amide based undercoats may include one or more additives, such that the underlying layer includes a amide resin based matrix. In exemplary embodiments, a single isocyanate component may be used to form both an amide based undercoat and a separately formed amide based matrix. In other exemplary embodiments, one isocyanate-reactive component and one isocyanate component may be used to form the amide based undercoat and additional isocyanate-reactive and isocyanate components may be used to form the overlaying amide based coating.

The mixture for forming the amide based may have an isocyanate index that is at least 60 (e.g., at least 100). For example, the isocyanate index may be from 60 to 2000 (e.g., 65 to 1000, 65 to 300, 65 to 250, 70 to 200, 100 to 900, 100 to 500, etc.) The isocyanate index is the equivalents of isocyanate groups (i.e., NCO moieties) present, divided by the total equivalents of isocyanate-reactive carboxylic acid containing groups (i.e., O═C—OH moieties) present, multiplied by 100. Considered in another way, the isocyanate index is the ratio of the isocyanate groups over the isocyanate reactive hydrogen atoms from a carboxylic acid present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

The isocyanate component for forming the amide based coating may include at least one polyisocyanates and/or at least one isocyanate-terminated prepolymer derived from the polyisocyanates, similar to as discussed above with respect to the isocyanate component of the base composition. Exemplary polyisocyanates include aromatic, aliphatic, and cycloaliphatic polyisocyanates. According to exemplary embodiments, the isocyanate component may only include aromatic polyisocyanates, prepolymers derived therefrom, and/or quasi-prepolymers derived therefrom, and the isocyanate component may exclude any aliphatic isocyanates and any cycloaliphatic polyisocyanates.

The polyisocyanates may have an average isocyanate functionality from 1.9 to 4 (e.g., 2.0 to 3.5, 2.8 to 3.2, etc.). The polyisocyanates may have an average isocyanate equivalent weight from 80 to 160 (e.g., 120 to 150, 125 to 145, etc.) The isocyanate-terminated prepolymer may have a free NCO (isocyanate moiety) of 10 wt % to 35 wt %, 10 wt % to 30 wt %, 10 wt % to 25 wt %, 10 wt % to 20 wt %, 12 wt % to 17 wt %, etc. Exemplary isocyanates include toluene diisocyanate (TDI) and variations thereof known to one of ordinary skill in the art, and diphenylmethane diisocyanate (MDI) and variations thereof known to one of ordinary skill in the art. Other isocyanates known in the polyurethane art may be used, e.g., known in the art for polyurethane based coatings. Examples, include modified isocyanates, such as derivatives that contain biuret, urea, carbodiimide, allophonate and/or isocyanurate groups may also be used.

The isocyanate-reactive component for forming the amide based coating includes one or more carboxylic acids, e.g., one or more poly-carboxylic acids. For example, the isocyanate-reactive component may include one or more poly-carboxylic acids (such as a simple carboxylic acid and/or a poly-carboxylic acid copolymer) that has a number average molecular weight from 90 g/mol to 10,000 g/mol. For example, the one or more poly-carboxylic acids may include one or more simple poly-carboxylic acids (also referred to as a poly-carboxylic acid monomers) such as a dicarboxylic acid and a tricarboxylic acid such as citric acid. For example, the dicarboxylic acid may have the general formula HO₂C(CH₂)ₙCO₂H.

For example, the one or more poly-carboxylic acids may include one or more poly-carboxylic acid copolymers that include two or more carboxylic acid end groups and a polymer backbone. Whereas, the carboxylic acid end groups may be referred to as a measure of the nominal carboxylic acid functionality of the copolymer. For example, the nominal carboxylic acid functionality may be from 2 to 8 (e.g., 2 to 6, 2 to 5, 2 to 4, and/or 2 to 3). For example the backbone may be an ether, ester, and/or carbonate based backbone. The ether, ester, and/or carbonate backbone may be non-reactive with the isocyanate-component. For example, the ether backbone may be a polyether derived from reaction of propylene oxide, ethylene oxide, and/or butylene oxide with an initiator. The ether backbone may have a number average molecular weight from 60 g/mol to less than 9950 g/mol. The poly carboxylic acid copolymer may be the reaction product of one or more polyether polyols and one or more anhydrides. Furthermore, the poly carboxylic acid can be derived from polyether polyols by direct oxidation of alcohol end groups.

The one or more poly-carboxylic acids may be pre-made as a blend prior to forming the amide based coating. For example, at least one poly-carboxylic acid copolymer and at least one poly-carboxylic acid monomer may be blended and maintained at a high temperature, such as at least 80° C.) over an extended period of time (such as at least 2 hours) to form the pre-made blend.

The isocyanate-reactive component for forming the amide based undercoat may further include a catalyst component that includes one or more catalysts, similar as discussed above with respect to the isocyanate-reactive component of the base composition. Catalysts known in the art, such as trimerization catalysts known in art for forming polyisocyanates trimers and/or urethane catalyst known in the art for forming polyurethane polymers and/or coatings may be used. In exemplary embodiments, the catalyst component may be pre-blended with the isocyanate-reactive component, prior to forming a coating. Other exemplary catalyst include amide forming catalysts that are known in the art, such as N-methyl imidazole and Lewis bases.

### Other Coatings for Aggregates

Other exemplary coatings for aggregates include coatings for contaminate removal/recovery and/or the addition of additives that may be used in the polymer concrete for various purposes. For example, a heavy metal recovery coating such as discussed in priority document, U.S. Provisional Patent Application No. 62/186,645, a controlled release polymer resin based coating such as discussed in U.S. Provisional Patent Application No. 62/312,113, and/or a sulfide recovery coating such as discussed in priority document, U.S. Provisional Patent Application No. 62/287,037 may be included.

For example, anyone of the heavy metal recovery coating, the controlled release polymer resin based coating, and the sulfide recovery coatings may allow for the addition of additives such as pigments to the coating to enable coloring of the polymer concrete.

### Additives

Various additives may be added to adjust characteristics of base composition, binder and/or coating(s), e.g., additives known to those of ordinary skill in the art may be used. Additives may be added as part of the isocyanate component (first and/or second) and/or the isocyanate-reactive component (first and/or second). Exemplary additives include a catalyst, an adhesion promoter, a moisture scavenger, a curative, a pH neutralizer, a plasticizer, a compatibilizer, a filler (such as functional fillers, silica based fillers, and mineral based fillers), pigments/dyes, and/or a crosslinker.

A catalyst component may be added that includes at least one catalyst, e.g., may be added to the isocyanate-reactive component. For example, the catalyst component may have tin and/or amine based catalysts, e.g., that accounts for less than 5 wt % of a total weight of the isocyanate-reactive component. For example, a commercially available catalyst may be used. The catalysts may be used in small amounts, such as from 0.0015 wt % to 5 wt % (e.g., 0.01 wt % to 1.0 wt %, etc.). Examples of catalysts include tertiary amines, tin carboxylates, organotin compounds, tertiary phosphines, various metal chelates, and/or metal salts of strong acids (such as ferric chloride, stannic chloride, stannous chloride, antimony trichloride, bismuth nitrate, and bismuth chloride).

An adhesion promoter component may be added that includes at least one adhesion promoter, e.g., may be added to the isocyanate-reactive component. For example, the adhesion promoter component may include at least one silane based adhesion promoter. If included, the optional adhesion promoter may account for less than 5 wt % of a total weight of the isocyanate-reactive component.

A moisture scavenger component may be added that includes at least one moisture scavenger, e.g., may be added to the isocyanate-reactive component. If included, the moisture scavenger component may account for 1 wt % to 20 wt % (e.g., 1 wt % to 15 wt %, 1 wt % to 10 wt %, 1 wt % to 5 wt %, 2 wt % to 5 wt %, etc.) of the total weight of the isocyanate-reactive component. Exemplary moisture scavengers include zeolites or molecular sieves, reactive silanes (such as vinyltrialkoxysilanes), and minerals (such as calcium oxide).

Fillers may be present to provide desired rheological properties, mechanical reinforcement, chemical resistance, and/or reduce cost. The fillers may be added to the isocyanate-reactive component and/or the isocyanate component. Examples of fillers include inorganic particulate materials such as talc, titanium dioxide, calcium carbonate, calcium oxide, silica, mica, wollastonite, fly ash, metal particles, carbon black, graphite, high melting organic polymers, and/or reinforcements. Fillers also include reinforcements type fillers, e.g., flake or milled glass and/or fumed silica, which may be used to impart certain properties. Fillers may constitute up to 90% by weight of the mixture for forming the cured composition.

A plasticizer may be present. If present, the plasticizer may be mixed with the isocyanate-reactive component, e.g., to reduce its viscosity to facilitate mixing with the isocyanate component, which may have a lower viscosity. The plasticizer may enable higher filler loading, reduce cost, and/or reduce modulus. Examples of suitable plasticizers include liquid (at 25° C.) esters of monocarboxylic acids and diesters of dicarboxylic acids having molecular weights of up to about 300.

Pigment and/or dyes may be present, e.g., titanium dioxide and/or carbon black, may be used to impart color properties. Other additives include, e.g., UV stabilizers, antioxidants, and air release agents, which may be independently used depending on the desired characteristics.

The one or more curatives (i.e., curative agents) may include an amine based curative such as a polyamine and/or an hydroxyl based curative such as a polyol. For example the one or more curatives may include one or more polyols, one or more polyamines, or a combination thereof. Curative known in the art for use in forming coatings may be used. The curative may be added, after first coating the proppant with the preformed aliphatic or cycloaliphatic isocyanurate tri-isocyanate. The curative may act as a curing agent for both the top coat and the undercoat. The curative may also be added, after first coating following the addition of the preformed aliphatic or cycloaliphatic isocyanurate tri-isocyanate in the top coat.

Various optional ingredients may be included in the reaction mixture for forming the controlled release polymer resin based coating, the additive based coating, and/or the above discussed additional coating/layer. For example, reinforcing agents such as fibers and flakes that have an aspect ratio (ratio of largest to smallest orthogonal dimension) of at least 5 may be used. These fibers and flakes may be, e.g., an inorganic material such as glass, mica, other ceramic fibers and flakes, carbon fibers, organic polymer fibers that are non-melting and thermally stable at the temperatures encountered in the end use application. Another optional ingredient is a low aspect ratio particulate filler, that is separate from the proppant. Such a filler may be, e.g., clay, other minerals, or an organic polymer that is non-melting and thermally stable at the temperatures encountered in stages (a) and (b) of the process. Such a particulate filler may have a particle size (as measured by sieving methods) of less than 100 μm. With respect to solvents, the undercoat may be formed using less than 20 wt % of solvents, based on the total weight of the isocyanate-reactive component.

### Aggregates

Exemplary aggregates include sand, siliceous chalk, gravel, greywacke, sandstone, limestone, and ceramic particles (for instance, aluminum oxide, silicon dioxide, titanium dioxide, zinc oxide, zirconium dioxide, cerium dioxide, manganese dioxide, iron oxide, calcium oxide, and/or bauxite). The aggregates are coated with polymers, e.g. to improve mesh effective strength (e.g., by distributing the pressure load more uniformly), to trap broken pieces under the surface (e.g., to reduce the possibility of the broken compromising the upper surface of the concrete), and/or to bond individual particles together when under intense pressure. The aggregates to be coated may have an average particle size from 50 μm to 3000 μm (e.g., 100 μm to 2000 μm). The aggregates may also be coated to have varying average particle sizes in order to provide a polymer concrete composition that includes aggregates of varies average particle sizes.

Aggregate (grain or bead) size may be related to performance of the resultant polymer concrete. Particle size may be measured in mesh size ranges, e.g., defined as a size range in which 90% of the proppant fall within. In exemplary embodiments, the aggregate is sand that has a mesh size of 20/40. Lower mesh size numbers correspond to relatively coarser (larger) particle sizes.

### Coating Process of Pre-Coated Aggregate

To pre-coated the aggregate, one or more coatings may be formed on (e.g., directly on) the aggregate and/or the optional underlying undercoat. In a first stage of forming coated aggregates, solid core aggregate particles (e.g., which do not have a previously formed resin layer thereon) may be heated to an elevated temperature. For example, the aggregate particles may be heated to a temperature from 50° C. to 250° C., e.g., to accelerate crosslinking reactions in the applied coating. The pre-heat temperature of the solid core aggregate particles may be less than the coating temperature for the coating formed thereafter. For example, the coating temperature may be from 40° C. to 170° C. and/or at least 85° C. and up to 170° C. The temperature for forming the pre-coated aggregates may be greater (e.g., at least 25° C. and/or at least 50° C. greater and optionally less than 150° C. greater) than the temperature for forming the binder (i.e., the temperature at which the isocyanate component and isocyanate-reactive component of the base composition are reacted). For example, the binder may be prepared at ambient conditions (temperature and pressure), while the pre-coated aggregates may be coated at the higher coating temperatures.

Next, the heated aggregate particles may be sequentially blended (e.g., contacted) with the desired components for forming the one or more coatings, in the order desired. For example, the aggregate particles may be blended with a formulation that includes one or more additives. Next, the aggregate particles may be blended with a first isocyanate-reactive component in a mixer, and subsequently thereafter other components for forming the desired one or more coatings. For an epoxy based matrix, the aggregate core particles may be blended with a liquid epoxy resin in the mixer. In exemplary embodiments, a process of forming the one or more coatings may take less than 10 minutes, after the stage of pre-heating the aggregate particles and up until right after the stage of stopping the mixer.

The mixer used for the coating process is not restricted. For example, as would be understood by a person of ordinary skill in the art, the mixer may be selected from mixers known in the specific field. For example, a pug mill mixer or an agitation mixer can be used. The mixer may be a drum mixer, a plate-type mixer, a tubular mixer, a trough mixer, or a conical mixer. Hobart mixers can be used. Mixing may be carried out on a continuous or discontinuous basis. It is also possible to arrange several mixers in series or to coat the aggregates in several runs in one mixer. In exemplary mixers it is possible to add components continuously to the heated aggregates. For example, isocyanate component and the isocyanate-reactive component may be mixed with the aggregate particles in a continuous mixer in one or more steps to make one or more layers of curable coatings.

Any coating formed on the aggregates may be applied in more than one layer. For example, the coating process may be repeated as necessary (e.g. 1-5 times, 2-4 times, and/or 2-3 times) to obtain the desired coating thickness. The thicknesses of the respective coatings of the aggregate may be adjusted. For example, the coated aggregates may be used as having a relatively narrow range of aggregate sizes or as a blended having aggregates of other sizes and/or types. For example, the blend may include a mix of aggregates having differing numbers of coating layers, so as to form an aggregate blend having more than one range of size and/or type distribution. The coating may be formed on a pre-formed polymer resin coated article (such as an aggregate).

The coated aggregates may be treated with surface-active agents or auxiliaries, such as talcum powder or steatite (e.g., to enhance pourability). The coated aggregates may be exposed to a post-coating cure separate from the addition of the curative. For example, the post-coating cure may include the coated aggregates being baked or heated for a period of time sufficient to substantially react at least substantially all of the available reactive components used to form the coatings. Such a post-coating cure may occur even if additional contact time with a catalyst is used after a first coating layer or between layers. The post-coating cure step may be performed as a baking step at a temperature from 100° C. to 250° C. The post-coating cure may occur for a period of time from 10 minutes to 48 hours.

The coating may include at least additive embedded on and/or within a polymer resin matrix. The one or more additives may be added during a process of forming the coating and/or may be sprinkled onto a previously coated solid core aggregate particle to form the coating in combination with another coating. For example, the one or more additives may be incorporated into an isocyanate-reactive component for forming the coating, an isocyanate component (e.g., a polyisocyanate and/or a prepolymer derived from an isocyanate and a prepolymer formation isocyanate-reactive component) for forming the coating, the prepolymer formation isocyanate-reactive component, and/or a prepolymer derived from an isocyanate and a one component system formation isocyanate-reactive component.

Optionally, the one or more additives may be provided in a carrier polymer. Exemplary carrier polymers include simple polyols, polyether polyols, polyester polyols, liquid epoxy resin, liquid acrylic resins, polyacids such as polyacrylic acid, a polystyrene based copolymer resins (exemplary polystyrene based copolymer resins include crosslinked polystyrene-divinylbenzene copolymer resins), Novolac resins made from phenol and formaldehyde (exemplary Novolac resins have a low softening point), and combinations thereof. Additives known to those of ordinary skill in the art may be used. Exemplary additives include moisture scavengers, UV stabilizers, demolding agents, antifoaming agents, blowing agents, adhesion promoters, curatives, pH neutralizers, plasticizers, compatibilizers, flame retardants, flame suppressing agents, smoke suppressing agents, and/or pigments/dyes.

### Polymer Concrete Composition

The polymer concrete composition may be prepared on site of use. For example, the polymer concrete composition may be prepared by mixing an isocyanate component of the base composition, an isocyanate-reactive component of the base composition, and the pre-coated aggregates (in varying orders) on site of intended use. The mixing may be performed at ambient temperature.

The polymer concrete composition may be mixed using a sufficiently large container (such as a bucket) and a high torque paddle mixer. To avoid/minimize splashing, a variable speed mixer may be used. In an exemplary process, agitating of the aggregates (pre-coated aggregates and/or uncoated aggregates) is started first with the mixer before the base composition is poured onto the aggregates. This process may avoid/minimize splashing of the base composition which starts off as a liquid. In another exemplary process, the base composition may be added to the container and the aggregates thereafter.

All parts and percentages are by weight unless otherwise indicated. All molecular weight information is based on number average molecular weight, unless indicated otherwise.

### Examples

Approximate properties, characters, parameters, etc., are provided below with respect to various working examples, comparative examples, and the materials used in the working and comparative examples.

### Polyurethane Pre-Coated Aggregate

| | |
|---|---|
| Sand | Northern White Frac Sand, having a 20/40 mesh |
| | size. |
| Polyol A | A poly(ethylene oxide) polyol made by |
| | ethoxylation of glycerine via potassium hydroxide |
| | based catalysis, having a number average |
| | molecular weight of approximately 620 g/mol |
| | (available from The Dow Chemical Company). |
| Isocyanate | A polymeric methylene diphenyl diisocyanate - |
| | also referred to as PMDI (available as PAPI ™ 27 |
| | from The Dow Chemical Company). |
| Adhesion Promoter | A gamma-aminopropyltrimethoxysilane based |
| | adhesion promoter (available as Silquest ™ A- |
| | 1100 from Momentive Performance Materials). |
| Catalyst 1 | A dibutyltin dilaurate based catalyst that promotes |
| | the urethane or gelling reaction (available as |
| | Dabco ® T-12 from Air Products and Chemicals |
| | Inc.). |

The polyurethane pre-coating aggregate is prepared by using a process in which from 2000 grams of the Sand is heated to a temperature of up to 120° C. in an oven. Then, the heat Sand is introduced into a KitchenAid® mixer equipped with a heating jacket (configured for a temperature of about 70° C.), to start a mixing process. During the above process, the heating jacket is maintained at 60% maximum voltage (maximum voltage is 120 volts, where the rated power is 425 W and rated voltage is 240V for the heating jacket) and the mixer is set to medium speed (speed setting of 5 on based on settings from 1 to 10). Separately, a Polyol Mixture is formed by mixing 4.15 grams of a 3:1 blend of Polyol A and glycerine by weight, 0.16 grams of Catalyst 1, and 0.4 grams of an organic pigment (DL-50291 Green, Plasticolors from Chromaflo). In the mixer, the heated Sand is allowed to attain a temperature of approximately 105° C. Next, 1.6 mL of the Adhesion Promoter is added to the mixture. Then, 15 seconds from the start of the addition of the Adhesion Promoter, the addition of the Polyol Mixture and 5.9 grams of the Isocyanate is simultaneously performed over a period of 1 minute. Next, the mixture is allowed to run for 45 additional seconds and the resultant polyurethane pre-coated aggregate is cooled, sieved, and collected.

The resultant polyurethane pre-coated aggregate is prepared at an isocyanate index of 90 and a loss on ignition (LOI), i.e. organic coating fraction of ˜0.5% (as calculated based on the total quantity of sand, plus the resin added to sand).

Polymer Concrete with Polyurethane Pre-Coated Aggregate

| | |
|---|---|
| Component 1 | Isocyanate component of a two-component |
| | polyurethane binder system (available as |
| | HYPERLAST ™ LU 1011 from The Dow |
| | Chemical Company). |
| Component 2 | Isocyanate-reactive component of a two- |
| | component polyurethane binder system (available |
| | as HYPERLAST ™ LP 5046 from The Dow |
| | Chemical Company). |

The polymer concrete of Working Examples 1, 2, and 3 and Comparative Example A are prepared according to the formulations in Table 1. The Working Examples 1-3 are prepared without adding any additional catalyst (such as the dibutyltin dilaurate based catalyst) and Working Example A is prepared using less than 0.1 wt % of Catalyst 1. To prepare the samples, Component 1 and 2 are poured in a plastic bucket and mixed manually with a mason's trowel for 1 minute. Next, the aggregate (i.e., the Sand, the Polyurethane Pre-coated Aggregate, or mixtures thereof) is added and the resultant mixture is constantly mixing to wet the aggregate with the polymer. Subsequently, the resultant mixture is poured into a 2″×2″×2″ cubic gang mold and allowed to cure for 24 hours at room temperature.

TABLE 1

| | | | |
|---|---|---|---|
| Working | Working | Working | Comparative |
| Ex. 1 | Ex. 2 | Ex. 3 | Ex. A |

Formulation (wt %)

| | | | | |
|---|---|---|---|---|
| Polyurethane | 80 | 40 | 20 | — |
| Pre-coated Aggregate | | | | |
| Sand | — | 40 | 60 | 80 |
| Component 1 | 13.2 | 13.2 | 13.2 | 13.2 |
| Component 2 | 6.8 | 6.8 | 6.8 | 6.8 |

Properties

| | | | | |
|---|---|---|---|---|
| Peak Compressive | 2785 | 1736 | 1544 | 1109 |
| Stress (psi) | | | | |
| % Compression Strain | 12.9 | 12.2 | 9.4 | 11.0 |
| at Peak Stress (%) | | | | |

Referring to the above, a trend of increasing compressive strength is observed as raw sand and coated sand are mixed together in different proportions. The system with 100% raw sand (i.e., Sand) resulted in the least compressive strength and the system with 100% coated sand (i.e., Polyurethane Pre-coated Aggregate) resulted in the maximum compressive strength. Further, when the coated sand is used, it was found the need for catalyst at this stage was obviated.

In exemplary embodiments, the polymer concrete composition may have a peak compressive stress that is greater than 1200 psi (e.g., greater than 1500 psi). The peak compressive stress may be up to 5000 psi. The polyol concrete composition may have a percent compression strain at peak stress that is greater than 8.0% (e.g., greater than 11.0%). The percent compression strain at peak stress may up to 30.0% (e.g., up to 20.0%).

Other pre-coated aggregates for polymer concrete are discussed below:

### Epoxy Pre-Coated Aggregate

Liquid epoxy resin based examples may be prepared using the following:

| | |
|---|---|
| Epoxy Resin 1 | A liquid epoxy resin that is a reaction product of |
| | epichlorohydrin and bisphenol A (available from |
| | Olin Corporation as D.E.R. ™ 331). |
| Epoxy Toughener | A toughened epoxy binder (available as |
| | VORASPEC ™ 58 from The Dow Chemical |
| | Company). |
| Epoxy Hardener | An aliphatic polyamine curing agent (available as |
| | D.E.H ™ 26 from Olin Corporation). |
| Polyether Polyol | An ethoxylated polyhydric polyol (available from |
| | The Dow Chemical Company). |

The liquid epoxy resin samples may be prepared in a process similar to as discussed in priority filing U.S. Provisional Patent Application No. 62/186,645. For example, samples may be prepared by blending the components (except the Epoxy Hardener and/or the Polyether Polyol) at 3500 rpm for 45 seconds in a FlackTek SpeedMixer™. Pigments may be used. Then, the blend may be placed in an oven for one hour at 60° C. Then, Epoxy Hardener and/or the Polyether Polyol may be added. A stoichiometric ratio of the Amino Hydrogen groups in the formulations to the Liquid Epoxy Resin is calculated as the Amino Hydrogen/LER stoichiometric ratio.

### Phenolic Resin Pre-Coated Aggregate

For phenolic resin based examples may be prepared using the following:

| | |
|---|---|
| Phenolic Resin 1 | A phenol-formaldehyde Novolac resin (available |
| | as SD-1731 from Hexion). |
| Phenolic Resin 2 | A resole resin (available as 102N68 from Georgia |
| | Pacific). |
| Polyol B | A blend of polyols (available from The Dow |
| | Chemical Company as TERAFORCE ™ 62575 |
| | Polyol). |
| HEXA | An aqueous solution of hexamethylenetetramine |
| | Hexamethylenetetramine (available from Sigma- |
| | Aldrich). |

The coating for examples is started when the Sand, have a temperature around 400° C., is introduced into a KitchenAid® mixer equipped with a heating jacket, to start a mixing process. During the above process, the heating jacket is maintained at 60% maximum voltage (maximum voltage is 120 volts, where the rated power is 425 W and rated voltage is 115V for the heating jacket) and the mixer is set to medium speed (speed setting of 5 on based on settings from 1 to 10). To start the coating process of the 2000 grams of Sand (after letting the temperature equilibrate to 375° F.), 40 grams of the Phenolic Resin 1 is added to the Sand in the mixer, while the medium speed is maintained. Separately, a polyol suspension of 11.0 grams of the Polyol B and 7.4 and grams of a solid additive such as zinc oxide is formed. Next, 18.4 grams of the polyol suspension is added to the mixer. After, 30 seconds from the addition of the polyol suspension, 36.0 grams of the HEXA is added to the mixer over a period of 30 seconds. Next, 25 grams of the Phenolic Resin 2 is added to the mixer. Then, 200 seconds after finishing the addition the Phenolic Resin 2, the mixer is stopped and the coated Sand is emptied onto a tray and allowed to cool at room temperature (approximately 23° C.).

### Preformed Isocyanurate Trimer Pre-Coated Aggregate

The materials principally used, and the corresponding approximate properties thereof, are as follows:

| | |
|---|---|
| Polyol C | A glycerine initiated propylene oxide based |
| | polyether triol, having a number average |
| | molecular weight of 250 g/mol (available from |
| | The Dow Chemical Company). |
| Polyol D | A glycerine initiated propylene oxide based |
| | polyether triol with ethylene oxide capping (EO |
| | content of less than 20 wt %), having a number |
| | average molecular weight of 4900 g/mol |
| | (available as VORANOL ™ 4701 from The Dow |
| | Chemical Company). |
| Isocyanate | Polymeric diphenylmethane diisocyanate (PMDI), |
| | having an NCO content of approximately 30.8 |
| | wt % (available from The Dow Chemical |
| | Company). |
| Catalyst 2 | A tertiary amine based catalyst that promotes the |
| | polyisocyanurate reaction, i.e., trimerization |
| | (available as Dabco ® TMR from Air Products ®). |
| IPDI Trimer | A preformed cycloaliphatic isocyanate based |
| | trimer (an isocyanurate triisocyanate) derived |
| | from isophorone diisocyanate, supplied at 70% |
| | solids in butyl acetate, having an isocyanate |
| | content of 12.3 wt %, and having an isophorone |
| | diisocyanate monomer content of less than 0.5% |
| | (available as Tolonate ™ IDT 70 B from |
| | Vencorex Chemicals). |
| TETA | A curative that is described as including at least |
| | 97% of triethylenetetramine (for example, |
| | available from Sigma-Aldrich ®). |
| Surfactant | A surfactant based on cocamidopropyl |
| | hydroxysultaine (for example, available from |
| | Lubrizol) |

Working Example 4 includes a multilayer coating of 2 wt % of an undercoat that is a polyurethane based layer and 1 wt % of a top coat prepared using the IPDI trimer, based on the total weight of the coated sand. In particular, the undercoat is prepared using the Polyol C, the Isocyanate, and Catalysts 1 and 2, at an isocyanate index of 150 and a coating temperature of 160° C. The top coat is prepared using the IPDI trimer, TETA, and the Catalyst 1 provided with the Polyol D as a carrier, at an isocyanate index of 100 and a coating temperature of 160° C.

In particular, Working Example 4 is prepared using 750 grams of the Sand, which is first heated in an oven to 170° C. to 180° C. Separately, in a beaker a First Pre-mix that includes 4.400 grams of the Polyol C, 0.150 grams of Catalyst 2, and 0.075 grams of Catalyst 1 is formed.

The heated Sand is introduced into a KitchenAid® mixer equipped with a heating jacket, to start a mixing process. During the above process, the heating jacket is maintained at 80% maximum voltage (maximum voltage is 120 volts, where the rated power is 425 W and rated voltage is 115V for the heating jacket) and the mixer is set to medium speed (speed setting of 5 on based on settings from 1 to 10). To form the undercoat layer on the Sand, the temperature of the Sand is checked periodically, and when the Sand has a temperature of 160° C., 0.6 mL of the Adhesion Promoter is added to the mixer. Then, 15 seconds from start of addition of the Adhesion Promoter, 4.6 grams of the First Pre-mix is added to the mixer over a period of 15 seconds. Next, 30 seconds after addition of the First Pre-mix, 10.6 grams of the Isocyanate is added over a period of 60 seconds to form a polyurethane based undercoat on the Sand.

Next, the top coat is formed on the coated Sand from above 30 seconds after addition of the Isocyanate is completed. Separately, in a beaker a Second Pre-mix that includes 1.000 gram of the Polyol B and 0.025 grams of the Catalyst 1 is formed. To form the top coat, firstly, the Second Pre-mix is added over a period of 15 seconds. Next, 15 seconds after the addition of the Second Pre-mix, 6.8 grams of IPDI trimer is added over a period of 60 seconds. Then, 30 seconds after addition of the IPDI trimer is completed, 0.7 grams of the TETA is introduced to the mixer over of period of 15 seconds and 1.0 mL of the Surfactant is added after 30 seconds. Then, 30 seconds later, the mixer is stopped (total of 5-6 minutes from start of addition of the Adhesion Promoter). Then, the dual layer coated Sand is emptied onto a tray and allowed to cool at room temperature (approximately 23° C.).

### Amide Pre-Coated Aggregate

For polyamide based examples, the materials principally used, and the corresponding approximate properties thereof, are as follows:

| | |
|---|---|
| Sand | Northern White Frac Sand, having a 20/40 mesh |
| | size. |
| Carboxylic Acid | A poly-carboxylic acid copolymer having that is |
| Copolymer 1 | an anionic modified poly-alkylene glycol, which |
| | is radically grafted by acrylic acid, having an acid |
| | functionality of approximately 4.5, and an acid |
| | number ranging from 59.5 to 72.9 according to |
| | ASTM D-4662 (available as UCON ™ EPML-483 |
| | from The Dow Chemical Company). |
| Carboxylic Acid | A poly-carboxylic acid copolymer that has a |
| Copolymer 2 | nominal carboxylic functionality of 3 and is a lab- |
| | synthesized acid-terminated polyether prepared by |
| | first, in 1 liter 4 neck RB flask, charged Polyol A |
| | to dry it at 90° C. under N₂ overnight, which is |
| | thereafter found to have a water content of 323 |
| | ppm. Next, the indicated amounts of succinic |
| | anhydride and 0.05 percent by weight of |
| | pyrogallol are charged into the flask. Under a |
| | nitrogen blanket, the temperature of the mixture is |
| | gradually raised to 90° C. or higher to dissolve the |
| | succinic anhydride in the IP 625 Polyol over a |
| | period of an hour with stirring at 350 rpm. Then, |
| | the temperature of the mixture is raised to 110° C. |
| | and held at about 110° C. for 3 hours. Lots of |
| | needle shape crystals may be observed on the top |
| | of the reactor and in the side arm. A heat gun may |
| | be used to get into the liquid twice. After cooling |
| | to room temperature, the nitrogen blanket is |
| | removed, and the product is analyzed by Acidity |
| | and NMR. Yield = 1474 grams, LIMS # 93215 |
| | for Acid # = 182.84 mg KOH/g for the sample. |
| Citric Acid | A polycarboxylic acid monomer that is citric acid |
| | which is available as 99% pure (available from |
| | Fisher Scientific). |
| Catalyst 1 | A 1-methylimidazole catalyst (available from |
| | Sigma ®). |
| Catalyst 2 | A tertiary amine based catalyst that promotes the |
| | polyisocyanurate reaction, i.e., trimerization |
| | (available as Dabco ® TMR from Air Products ®). |

The amide based coating is generally prepared by using a process in which from 600 to 750 grams of the Sand is heated to a temperature of up to 180° C. in an oven. Then, the heat Sand is introduced into a KitchenAid® mixer equipped with a heating jacket (configured for a temperature of about 70° C.), to start a mixing process. During the above process, the heating jacket is maintained at 60% maximum voltage (maximum voltage is 120 volts, where the rated power is 425 W and rated voltage is 240V for the heating jacket) and the mixer is set to medium speed (speed setting of 5 on based on settings from 1 to 10). Separately, for the Working Examples in the manner indicated below, a mixture of the blend of the Carboxylic Acid Copolymer 1 or 2 and the Citric Acid is prepared, and then the blend is further mixed with the Catalyst 1 and/or 2 to form the blend with Catalyst. In the mixer, the heated Sand is allowed to attain a temperature of 130-135° C. Next, simultaneously the addition of the Isocyanate addition and addition of the blend with the Catalyst is performed. A free-flowing product is obtained within a range of approximately 3 to 5 minutes. The surface of the resin coated aggregates is characterized by ATR-IR spectroscopy and scanning electron microscopy (SEM). Referring to FIG. 1, Scanning electron microscopy images (25 kV) of amide based coating on sand is shown, in which top row (a), the amide based coating is thicker in darker areas and the bottom row (b) uncoated sand is lighter. Individual coating examples are discussed below.

Working Example 5 has a coated structure that includes LOI˜3.7%, polyamide based coating, isocyanate index of 1.0, and cycle time of 3 minutes. The sample is prepared using 600 grams of the Sand heated in an oven to 160° C., then introduced into the KitchenAid® mixer. After temperature of the Sand reaches 132° C., 0.6 mL of the Adhesion Promoter is added to the mixer. Then, 15 seconds from start of addition of the Adhesion Promoter, 17.2 grams of premixed acid Carboxylic Acid Copolymer 1/Citric Acid at a ratio of 9:1 (16.5 grams) with Catalyst 1 (0.7 grams) is added simultaneously with 6.0 grams of Isocyanate over a period of 1.25 minutes. The mixer is stopped after 1.5 minutes. Material is emptied onto a tray and allowed to cool.

Working Example 6 has a coated structure that includes LOI˜3%, polyamide based coating, isocyanate index of 2, and cycle time of 3 minutes. The sample is prepared using 750 grams of the Sand is heated in an oven to 160° C., then introduced into the KitchenAid® mixer. After temperature of the Sand reaches 135° C., 0.6 mL of the Adhesion Promoter is added to the mixer. Then, 15 seconds from start of addition of the Adhesion Promoter, 13.0 grams of premixed acid Carboxylic Acid Copolymer 2 (12 grams) with Catalyst 1 (0.8 grams) and Catalyst 2 (0.2 grams) are added simultaneously with 10.5 grams of Isocyanate over a period of 1.25 minutes. The mixer is stopped after 1.5 minutes. Material is emptied onto a tray and allowed to cool.

1. A polymer concrete composition, comprising:
a base composition including a first isocyanate component and a first isocyanate-reactive component; and
one or more pre-coated aggregates, each having a base substrate and a two-component reaction product polymeric coating on an outer surface of the base substrate, the polymeric coating being the reaction product of a second isocyanate component and a second isocyanate-reactive component.

2. The composition as claimed in claim 1, wherein the two-component reaction product polymeric coating is a polyurethane based coating, an epoxy based coating, a phenolic resin based coating, a preformed isocyanurate based coating, or an amide based coating.

3. The composition as claimed in claim 1, wherein the base composition is curable to form a polyurethane based binder prepared at an isocyanate index from 95 to 300.

4. The composition as claimed in claim 3, wherein the polyurethane based binder is prepared as the reaction product of the first isocyanate component and the first isocyanate-reactive component in the presence of the one or more pre-coated aggregates.

5. The composition as claimed in claim 4, wherein second isocyanate component and the second isocyanate-reactive component are reacted to form the two-component reaction product polymeric coating prior to forming the polyurethane based binder.

6. The composition as claimed in claim 1, wherein the one or more pre-coated aggregates are coated with the two-component reaction product polymeric coating prior to forming the polymer concrete composition.

7. The composition as claimed in claim 1, wherein the first isocyanate-reactive component includes one or more polyols and the second isocyanate-reactive component is different from the first isocyanate-reactive component.

8. A cured polymer concrete, comprising the polymer concrete composition as claimed in claim 1.

9. A method of preparing the polymer concrete composition as claimed in claim 1, comprising:
providing the one or more pre-coated aggregates in a container;
adding the first isocyanate component and the first isocyanate-reactive component to the container; and
mixing the one or more pre-coated aggregates and the base composition.

10. A method of repairing a concrete substrate using the polymer concrete composition as claimed in claim 1, comprising:
providing the one or more pre-coated aggregates in a container;
adding the first isocyanate component and the first isocyanate-reactive component to the container;
mixing the one or more pre-coated aggregates and the base composition to form a mixed polymer concrete composition; and
applying the mixed polymer concrete composition to the concrete substrate.
